(19) United States
(12) Patent Application Publication
(10) Pub. No.: US 2026/0147172 A1
(43) Pub. Date: May 28, 2026

(54) OPTICAL MODULE AND ASSEMBLING METHOD THEREOF

(71) Applicant: Molex, LLC, Lisle, IL (US)

(72) Inventors: Tian WANG, Wuhan City (CN); Xing Wang Zhan, Wuhan City (CN)

(21) Appl. No.: 19/383,195

(22) Filed: Nov. 7, 2025

(30) Foreign Application Priority Data
Nov. 28, 2024 (CN) 202411734563.3

(51) Int. Cl. G02B 6/42; G02B 6/38

(52) U.S. Cl. CPC G02B 6/4292; G02B 6/3897; G02B 6/4269

(57) ABSTRACT

An optical module and an assembling method of an optical module are provided. An example optical module includes a housing, a circuit board, a plurality of optical fiber receptacles and a receptacle bracket. The plurality of optical fiber receptacles are coupled with the circuit board via optical fibers. The receptacle bracket is provided in front of the optical interface, and an elastic locking arm of the receptacle bracket is provided with a position-limiting portion. An inner side wall of a receiving groove of the housing is provided with an inserting portion, a locking portion, and a one-way passing portion. The position-limiting portion of the elastic locking arm is fitted in the housing from the inserting portion and is capable of sliding over the one-way passing portion, entering into the locking portion, and abutting against the locking portion, so that the receptacle bracket is locked to housing.

### TECHNICAL FIELD

The present disclosure relates to the technical field of optical communications and particularly relates to an optical module and an assembling method thereof.

### BACKGROUND

Chinese patent CN111897060B discloses an optical module. The optical module includes a housing, and a circuit board, a photoelectric chip and an optical fiber module which are provided in the housing. Wherein, the housing includes a lower housing and an upper housing. The lower housing is provided with a recessed groove which is used to receive the optical fiber module, the optical fiber module is received in the recessed groove to limit the optical fiber module in position and fix the optical fiber module.

The optical fiber module includes optical fibers and a connecting assembly. The connecting assembly includes an optical fiber connector, a fixing member and optical fiber handles. The connecting assembly is used to fix the optical fiber handles on the optical fiber connector. In this solution, in a process of assembling of the optical fiber module, it needs that, the optical fiber handles are inserted into holes in the optical fiber connector, and then an upper connecting plate and a lower connecting plate mate with each other up and down to fix the optical fiber handles, and, the upper connecting plate and the lower connecting plate are further fixed with the optical fiber connector by hole structures and a groove structure. Such a connecting assembly is complex in structure, is more in parts, so in the process of assembling of the optical fiber module, operation is more in step. And in the assembling process, the optical fibers are easily pulled, thereby resulting in fracture of the optical fiber which is thin, thus it is not convenient to manufacture, and is lower in production efficiency.

### SUMMARY

A technical problem to be solved by the present disclosure is to propose an optical module which is simplified in structure and can realize convenient assembling so as to overcome deficiency existing in the prior art.

The present disclosure proposes an example optical module comprising a housing which is provided with a receiving groove extending along a front-rear direction, an inner side wall of the receiving groove is provided with an inserting portion and a locking portion along the front-rear direction, the inserting portion is positioned in front of the locking portion, the inserting portion and the locking portion are further provided therebetween with a one-way passing portion, a rear side of the housing is provided with an optical interface; a circuit board which is received in the receiving groove, a front end of the circuit board forwardly extends out of the housing to form an electrical interface; a plurality of optical fiber receptacles which are coupled with the circuit board via optical fibers; and a receptacle bracket, the receptacle bracket is provided in front of the optical interface, the receptacle bracket comprises a panel and an elastic locking arm which is provided to two sides of the panel respectively, the plurality of optical fiber receptacles snap on the panel, the elastic locking arm is provided with a position-limiting portion; the position-limiting portion of the elastic locking arm is capable of rearwardly sliding over the one-way passing portion from the inserting portion, entering into the locking portion and abutting against the locking portion, so that the receptacle bracket is locked to the housing, and the plurality of optical fiber receptacles are aligned with and fastened to the optical interface.

In one aspect, the inserting portion is an inserting groove which is recessed outwardly, the locking portion is a locking groove which is recessed outwardly, the one-way passing portion is a one-way passing protrusion which protrudes inwardly relative to the inserting groove and the locking groove.

In another aspect, the position-limiting portion is a position-limiting protrusion which protrudes outwardly from an outer side of the elastic locking arm, a rear side surface of the position-limiting protrusion is provided with a first guiding surface, a front side surface of the one-way passing protrusion is a second guiding surface, the first guiding surface and the second guiding surface are inclined relative to the front-rear direction.

In one embodiment, the panel is provided perpendicular to the bottom of the receiving groove, the at least two elastic locking arms forwardly extend respectively from two opposite sides of the panel.

In one embodiment, a front side surface of the position-limiting protrusion is a first position-limiting surface, a rear side surface of the one-way passing protrusion which is toward the locking groove is a second position-limiting surface, the first position-limiting surface abuts against the second position-limiting surface.

In one embodiment, the optical module further comprises a cover and a locking assembly, the cover covers above the housing to close the receiving groove, the cover is provided with a heat sink; the locking assembly comprises a handle and a sliding arm which is fixed in front of the handle, a front end of the sliding arm is provided with a latch.

In one embodiment, the optical fiber receptacle comprises an optical fiber ferrule and a front stopping edge and a rear stopping edge which are provided to an outer side of the optical fiber ferrule, the front stopping edge and the rear stopping edge respectively attach to a front side and a rear side of the panel to limit the optical fiber ferrule in position.

In one embodiment, the optical fiber receptacle further comprises an elastic gasket, the elastic gasket sheathes an outer periphery of the optical fiber ferrule, and the elastic gasket is provided between the rear stopping edge and the housing.

In one embodiment, the panel is provided with a plurality of snapping grooves which are used to snap the plurality of optical fiber receptacles respectively, the plurality of snapping grooves comprises a first snapping groove and a second snapping groove which are arranged up and down, an opening of the first snapping groove is toward an upper side edge of the panel, an opening of the second snapping groove is toward a lower side edge of the panel.

In one embodiment, the circuit board and the receptacle bracket is further provided therebetween with a spacing member, the spacing member is provided with a plurality of slits to correspondingly snap different optical fibers.

An assembling method of an optical module is further provided.

An example method of assembling an optical module comprises providing a housing, a circuit board provided in an interior of the housing and a plurality of optical fiber receptacles connected to the circuit board via optical fibers, a rear end of the housing is provided with one optical interface, the interior of the housing is provided with a receiving groove, an inner side wall of the receiving groove is provided with an inserting portion and a locking portion along a front-rear direction, and the inserting portion and the locking portion are provided therebetween with a one-way passing portion; providing a receptacle bracket, the receptacle bracket comprises a panel and two elastic locking arms which extend forwardly from two sides of the panel, the panel is provided with a plurality of snapping grooves, the elastic locking arm is provided with a position-limiting portion; firstly snapping the plurality of optical fiber receptacles into the plurality of snapping grooves of the receptacle bracket respectively; then fitting the receptacle bracket into the housing to downwardly fit the position-limiting portion of the elastic locking arm into the inserting portion; then pushing the receptacle bracket rearwardly to make the position-limiting portion of the elastic locking arm slide over the one-way passing portion and finally abut against the locking portion, the receptacle bracket locked onto the housing, and the plurality of optical fiber receptacles aligned with and fastened to the optical interface.

In one embodiment, the inserting portion is an inserting groove which is recessed outwardly, the locking portion is a locking groove which is recessed outwardly, the one-way passing portion is a one-way passing protrusion which protrudes inwardly relative to the inserting groove and the locking groove.

In one embodiment, the position-limiting portion is a position-limiting protrusion which protrudes outwardly from an outer side of the elastic locking arm, a rear side of the position-limiting protrusion is provided with a first guiding surface, a front side surface of the one-way passing protrusion is a second guiding surface, the first guiding surface and the second guiding surface are inclined relative to the front-rear direction, in an assembling process, the first guiding surface of the position-limiting protrusion slides over the one-way passing protrusion along the second guiding surface of the one-way passing protrusion.

In one embodiment, a front side surface of the position-limiting protrusion is a first position-limiting surface, a rear side surface of the one-way passing protrusion which is toward the locking groove is a second position-limiting surface, the first position-limiting surface and the second position-limiting surface are perpendicular to the front-rear direction; after the assembling is completed, the first position-limiting surface of the elastic locking arm abuts against the second position-limiting surface of the one-way passing protrusion.

In comparison with the prior art, the present disclosure at least has the following advantages: the receptacle bracket of the optical module of the present design is an integral element, is simple in structure, and is low in manufacturing cost; when the optical module of the present embodiment is assembled according to the assembling method, the position-limiting portion of the elastic locking arm of the receptacle bracket is fitted from the inserting portion of the housing, after the position-limiting portion enters into the receiving groove, the plurality of optical fiber receptacles on the receptacle bracket are just aligned with the optical interface. And then the receptacle bracket is pushed rearwardly, to make the position-limiting portion of the elastic locking arm slide into the locking portion from the inserting portion, at the same time make the plurality of optical fiber receptacles on the receptacle bracket inserted into and fixed in optical interface. Therefore, in the assembling process of the optical module, it only needs to one inserting and one pushing of the receptacle bracket, it may realize that the plurality of optical fiber receptacles are inserted into and fixed into the optical interface at the same time, operation is simple. Locking cooperation between the locking portion and the position-limiting portion of the elastic locking arm may retain position-limiting on the receptacle bracket, and assure the plurality of optical fiber receptacles to be stably mounted.

In a process of inserting the optical fiber receptacles into the optical interface, in a traditional manner, optical fiber receptacles need to be aligned with and fitted to specified positions in a housing by one-to-one correspondence, the optical fiber receptacles are prone to interfere with each other, optical fibers are pulled and the optical fibers are damaged. However, in the optical module of the present embodiment, because the plurality of optical fiber receptacles are moved to a specified position from front to rear at the same time and the plurality of optical fiber receptacles are aligned with the optical interface, the plurality of optical fiber receptacles are not prone to interfere with each other, damage to the optical fibers is avoided, and operation is convenient and is beneficial to promote production efficiency.

### BRIEF DESCRIPTION OF THE DRAWINGS

FIG. 1 is a schematic view of an optical module of the present disclosure;

FIG. 2 is an exploded schematic view of the optical module as shown in FIG. 1;

FIG. 3 is a side view of the optical module as shown in FIG. 1;

FIG. 4 is a cross-sectional view of the optical module as shown in FIG. 3;

FIG. 5 is an exploded view of a housing, an optical fiber receptacle and a receptacle bracket as shown in FIG. 2;

FIG. 6 is an exploded view of the optical fiber receptacle and the receptacle bracket as shown in FIG. 5;

FIG. 7 is a perspective view that the optical fiber receptacle of the optical module as shown in FIG. 2 does not insert into an optical interface;

FIG. 8 is a partially enlarged view of a part C of the optical module as shown in FIG. 7;

FIG. 9 is a side view of the optical module as shown in FIG. 7;

FIG. 10 is a perspective schematic view that the optical fiber receptacle of the optical module as shown in FIG. 7 inserts into the optical interface;

FIG. 11 is a partially enlarged view of a part D of the optical module as shown in FIG. 10;

FIG. 12 is a side view of the optical module as shown in FIG. 10; and

FIG. 13 is a flow chart of an assembling method of an optical module of the present disclosure.

### DETAILED DESCRIPTION

While the present disclosure may be susceptible to embodiments in different forms, there are shown in the figures, and will be described herein in detail, are only specific embodiments, with the understanding that the present disclosure is to be considered as an exemplification of the principles of the present disclosure, and is not intended to limit the present disclosure to that as illustrated.

Hence references to a feature are intended to describe a feature of an embodiment of the present disclosure, not to imply that every embodiment thereof must have the described feature. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the figures, representations of directions such as up, down, left, right, front and rear, used for explaining the structure and movement of the various parts of the present disclosure, are not absolute, but relative. These representations are appropriate when the parts are in the position shown in the figures. If the description of the position of the parts changes, however, these representations are to be changed accordingly.

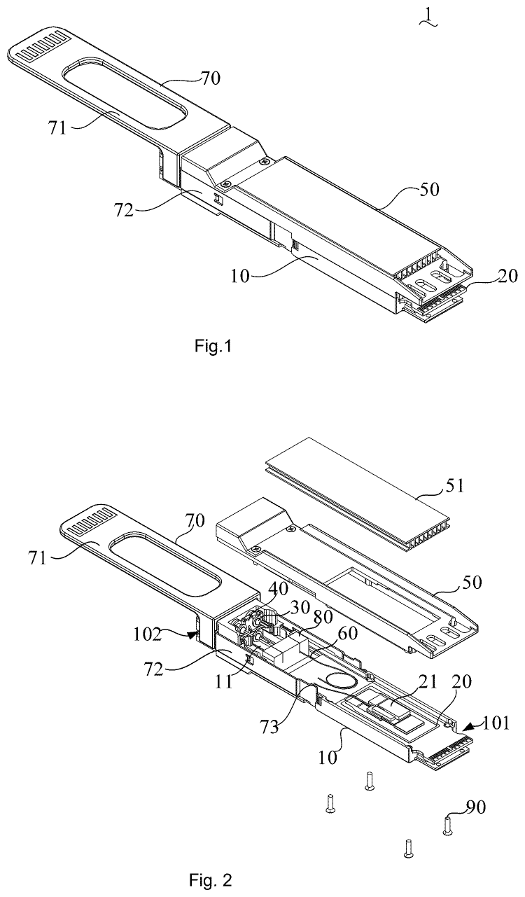

Referring to FIG. 1 and FIG. 2, an optical module 1 mainly includes a housing 10, a circuit board 20, a plurality of optical fiber receptacles 30 and a receptacle bracket 40. The circuit board 20, the plurality of optical fiber receptacles 30 and the receptacle bracket 40 are received in the housing 10. The plurality of optical fiber receptacles 30 are fixed in the housing 10 via the receptacle bracket 40. The optical fiber receptacle 30 is connected with the circuit board 20 in photoelectric coupling via an optical fiber. The optical module 1 may be adapted to connect communication signals between photoelectric devices to realize signal transmission.

The housing 10 is elongated, the housing 10 is provided therein with a receiving groove 11 along a front-rear extending direction of the housing 10. The optical module 1 further includes a cover 50. The cover 50 covers above the housing 10 to close the receiving groove 11, the cover 50 and the housing 10 latch with each other to make the receiving groove 11 form a closed type receiving cavity. The circuit board 20, the plurality of optical fiber receptacles 30 and the receptacle bracket 40 are provided in the receiving cavity. The cover 50 and the housing 10 may be fastened with each other by latching, screwing and the like.

Specifically, after the cover 50 is provided onto the housing 10, the cover 50 and the housing 10 are fastened together by bolts 90. A bottom of the housing 10 may be provided with threaded holes, the cover 50 is correspondingly provided with counterbored holes.

The cover 50 is provided with a heat sink 51. The heat sink 51 can promote heat dissipating effect of the optical module 1. The heat sink 51 which are stacked in multiple layers may be soldered and fixed to the cover 50 by a reflow soldering process, and may have higher heat dissipating performance.

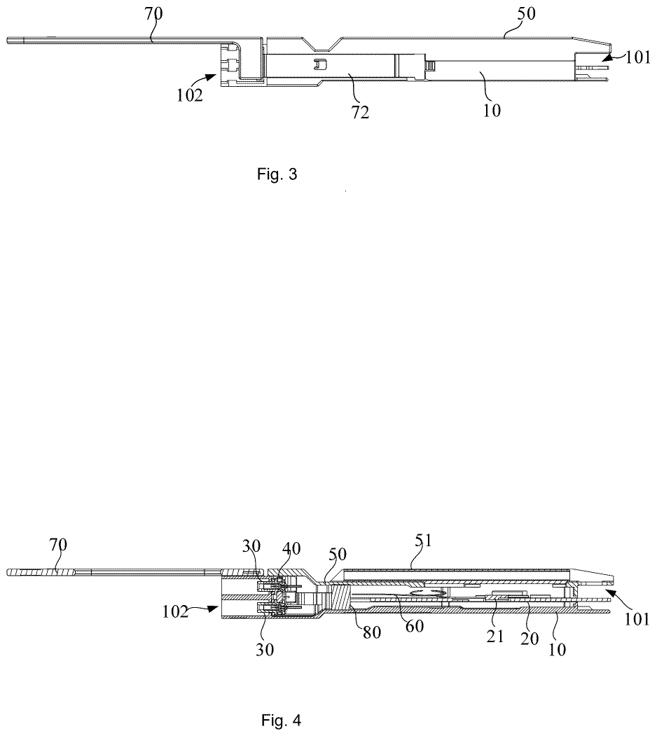

Referring to FIG. 3 and FIG. 4, a front end of the housing 10 is an electrical interface 101, and a rear end of the housing 10 is an optical interface 102. The receiving groove 11 also is elongated, and is provided along a front-rear direction. The optical interface 102 of the housing 10 may be a hole structure, so that the plurality of optical fiber receptacles 30 can be stably received in the optical interface 102. One end of the optical interface 102 is positioned on a rear side wall of the receiving groove 11. The optical interface 102 communicates the receiving groove 11 and an exterior of the housing 10. The one end of the optical interface 102 is used to allow the plurality of optical fiber receptacles 30 to pass therethrough, the other end of the optical interface 102 is used to be connected with an external optical receptacle, so that the external optical receptacle may transmit optical signals with the plurality of optical fiber receptacles 30 which are provided in the optical interface 102.

The circuit board 20 is mounted in the receiving groove 11 and is provided close to the electrical interface 101. A photoelectric chip 21 is provided on the circuit board 20, and is electrically connected with the circuit board 20. The optical fiber 60 transmits an optical signal between the photoelectric chip 21 and the optical interface 102. The circuit board 20 is received in the receiving groove 11, a front end of the circuit board 20 is provided with golden fingers, the golden fingers are used to be electrically connected with another signal device. The front end of the circuit board 20 which is provided with the golden fingers forwardly protrudes into the electrical interface 101.

The plurality of optical fiber receptacles 30 are signal connected with the circuit board 20 by the optical fibers 60. One ends of the optical fibers 60 are optically coupled with the photoelectric chip 21. The circuit board 20 and the receptacle bracket 40 are further provided therebetween with a spacing member 80. The spacing member 80 is provided with slits which correspondingly snap different optical fibers 60, are used to organize the optical fibers 60, avoid the optical fibers 60 interfering and entangling with each other.

The other ends of the optical fibers 60 are connected to the plurality of optical fiber receptacles 30, the plurality of optical fiber receptacles 30 are mounted to the optical interface 102. The optical module 1 directly uses the optical fibers 60 to transmit the optical signals between the photoelectric chip 21 and the optical interface 102, the plurality of optical fiber receptacles 30 are directly assembled in the optical interface 102, which can save an intervening adapter, make structure simpler and compact, and make assembling more convenient.

The receptacle bracket 40 is used to support the plurality of optical fiber receptacles 30, the receptacle bracket 40 is capable of fixing the plurality of optical fiber receptacles 30 in the optical interface 102. During optical signal transmission of the optical module 1, it needs to retain that the optical fiber receptacle 30 has higher stability and cannot shake, move and the like. When the optical fiber receptacle 30 is inserted into the optical interface 102, the optical fiber receptacle 30 is limited by the receptacle bracket 40 so as to avoid the optical fiber receptacle 30 axially moving along the optical interface 102. Therefore, by the receptacle bracket 40 and the optical interface 102, the optical fiber receptacle 30 may be limited in position axially and circumferentially respectively, thereby assuring that a position of the optical fiber receptacle 30 is retained stably.

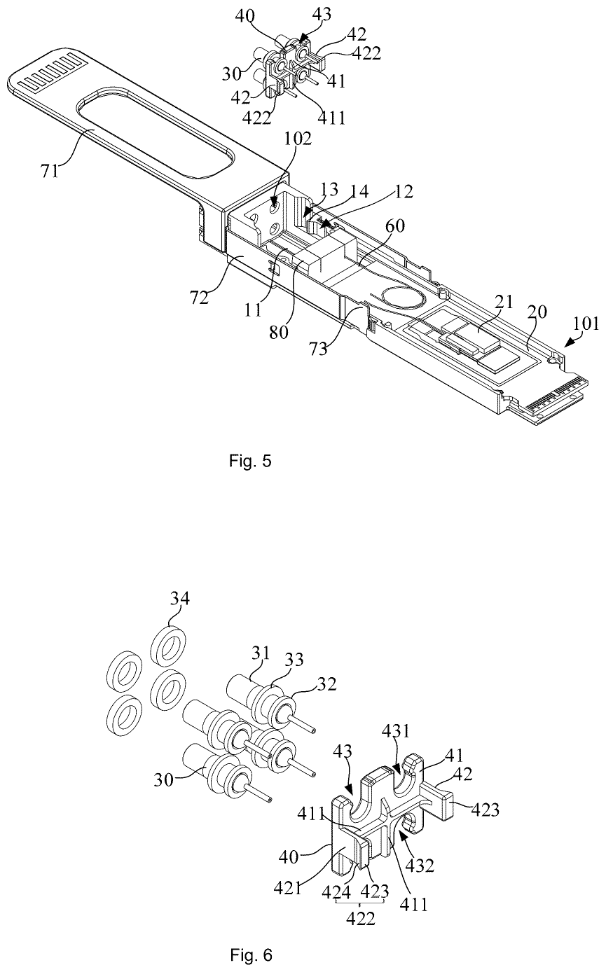

Referring to FIG. 5, specifically, in the present embodiment, the receptacle bracket 40 is provided close to and in front of the optical interface 102, so as to make the plurality of optical fiber receptacles 30 aligned with the optical interface 102. The receptacle bracket 40 includes a panel 41 and an elastic locking arm 42 which is provided to two sides of the panel 41 respectively. Wherein, the panel 41 is provided perpendicular to a bottom of the receiving groove 11. The panel 41 is provided with a plurality of snapping grooves 43. The plurality of snapping grooves 43 are used to snap the plurality of optical fiber receptacles 30 respectively. A tip of the elastic locking arm 42 is provided with a position-limiting portion, in some embodiment not shown, the position-limiting portion also may be provided at a middle position of the elastic locking arm 42. Specifically, in the present embodiment, the position-limiting portion is a position-limiting protrusion 422 which protrudes toward an inner side wall of the receiving groove 11. The receptacle bracket 40 is fixed with the housing 10 by the elastic locking arm 42.

The inner side wall of the receiving groove 11 is provided with an inserting portion and a locking portion along the front-rear direction, specifically, in the present embodiment, the inserting portion is an inserting groove 12 which is recessed outwardly from the inner side wall of the receiving groove 11, the locking portion is a locking groove 13 which is recessed outwardly from the inner side wall of the receiving groove 11.

The inserting groove 12 is positioned in front of the locking groove 13. The inserting groove 12 and the locking groove 13 is further provided therebetween with a one-way passing portion, specifically, in the present embodiment, the one-way passing portion is a one-way passing protrusion 14 which protrudes inwardly relative to the inserting groove 12 and the locking groove 13. The position-limiting protrusion 422 of the elastic locking arm 42 is fitted into the housing 10 from the inserting groove 12. The receptacle bracket 40 is then rearwardly moved to make the position-limiting protrusion 422 of the elastic locking arm 42 slide over the one-way passing protrusion 14 from the inserting groove 12 to enter into the locking groove 13 and abut against the locking groove 13, so that the receptacle bracket 40 is locked onto the housing 10, the plurality of optical fiber receptacles 30 are inserted into and fastened in the optical interface 102.

In another embodiment not shown, the concave-convex latching cooperation relationship among the position-limiting protrusion 422 of the elastic locking arm 42 and the inserting groove 12 and the locking groove 13 may be further varied as: the inserting portion further may be an inserting protrusion which protrudes inwardly from the inner side wall of the receiving groove, the locking portion may be a locking protrusion which protrudes inwardly from the inner side wall of the receiving groove. The one-way passing portion may be a one-way passing recessed groove, the one-way passing recessed groove is recessed outwardly relative to the inserting protrusion and the locking protrusion. The inserting protrusion and the locking protrusion protrude toward an inner side of the receiving groove, the one-way passing recessed groove may be recessed toward an outer side of the receiving groove. The position-limiting portion of the elastic locking arm may be a position-limiting recessed groove. The position-limiting recessed groove is recessed inwardly from an outer side of the elastic locking arm. The position-limiting recessed groove is inserted into the receiving groove from the inserting protrusion, and is moved along the one-way passing recessed groove, and abuts against the locking protrusion.

In the optical module 1 of the present embodiment, the position-limiting protrusion 422 of the elastic locking arm 42 of the receptacle bracket 40 is inserted from the inserting groove 12 (the inserting portion), after the elastic locking arm 42 enters into the receiving groove 11 respectively, the plurality of optical fiber receptacles 30 on the receptacle bracket 40 are just aligned with the optical interface 102. The receptacle bracket 40 is then pushed rearwardly, to make the elastic locking arm 42 slide into the locking groove 13 (the locking portion) from the inserting groove 12 (the inserting portion), at the same time make the plurality of optical fiber receptacles 30 on the receptacle bracket 40 inserted into the optical interface 102. Therefore, in an assembling process of the optical module 1, as for fitting of the plurality of optical fiber receptacles 30, it only needs that the receptacle bracket 40 is firstly downwardly inserted and is then pushed rearwardly, it may realize that the plurality of optical fiber receptacles 30 are inserted into the optical interface 102 at the same time, operation is simple and it may prevent the optical fibers 60 from entangling with each other and being damaged. Locking cooperation between the locking groove 13 and the elastic locking arm 42 may retain position-limiting on the receptacle bracket 40, thereby assuring firm mount of the plurality of optical fiber receptacles 30.

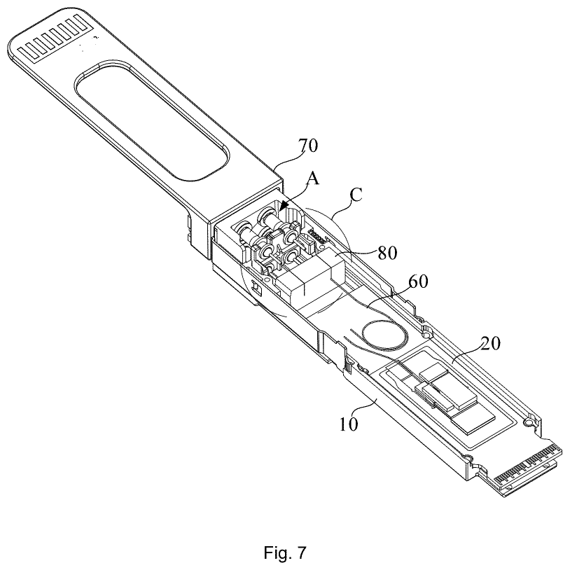

Referring to FIG. 5 and FIG. 7, specifically, in the present embodiment, the optical module 1 further includes a locking assembly 70. The locking assembly 70 includes a handle 71 and a sliding arm 72 which is fixed in front of the handle 71. The handle 71 is mounted behind the housing 10, is used to conveniently pull the optical module 1. A front end of the sliding arm 72 is provided with a latch 73 which is used to latch with a switch and the like. When the optical module 1 inserts into a port of a casing (not shown) of the switch, the optical module 1 and the casing realize latching and fixing by the latch 73.

Specifically, in the present embodiment, the sliding arm 72 is slidably provided to outer sides of two side walls of the housing 10. The sliding arm 72 and the side wall of the housing 10 is provided therebetween with an elastic member 74. Two ends of the elastic member 74 respectively abut against between the sliding arm 72 and the side wall of the housing 10. The elastic member 74 may be a spring and the like.

When an operator pulls the handle 71, the handle 71 brings the sliding arm 72 to move relative to the housing 10, latching of the latch 73 of the sliding arm 72 is released, the elastic member 74 is compressed, so that it may realize separation between the optical module 1 and the casing. When the optical module 1 is pulled out from the casing, the elastic member 74 restores elasticity and deforms to make the sliding arm 72 return to an original position thereof.

Referring to FIG. 6, specifically, in the present embodiment, each optical fiber receptacle 30 includes an optical fiber ferrule 31, and a front stopping edge 32, a rear stopping edge 33 and an elastic gasket 34 which sheathe an outer side of the optical fiber ferrule 31. The optical fiber ferrule 31 is connected with the optical fiber 60. The front stopping edge 32 and the rear stopping edge 33 are spaced apart from each other.

The elastic gasket 34 sheathes the optical fiber ferrule 31, the elastic gasket 34 is provided between the rear stopping edge 33 and the housing 10, the elastic gasket 34 has certain elasticity so that the elastic gasket 34 may absorb vibration and fitting tolerance. The elastic gasket 34 may be a conductive rubber ring. The elastic gasket 34 can form electromagnetic shielding between the optical interface 102 and the optical fiber receptacle 30, to promote performance of the optical module 1 in anti-electromagnetic interference.

Specifically, in the present embodiment, the optical fiber receptacles 30 are four in number. The four optical fiber receptacles 30 are distributed as a rectangle. The optical fiber receptacles 30 further may be plural in number, for example, six, eight and the like. According to different use requirement, there may be different arrangement manner.

A shape of the snapping groove 43 can correspondingly snap the optical fiber ferrule 31. An opening of the snapping groove 43 is provided with a necking portion, the necking portion may embrace an outer side wall of the optical fiber ferrule 31, so that the optical fiber ferrule 31 may be stably received in the snapping groove 43. The panel 41 is interposed between the front stopping edge 32 and the rear stopping edge 33, and, the front stopping edge 32 and the rear stopping edge 33 respectively abut against a front side surface and a rear side surface of the panel 41 to limit the optical fiber ferrule 31 in position. Therefore, the front stopping edge 32 and the rear stopping edge 33 perform position-limiting on the optical fiber ferrule 31 in an axial direction of the optical fiber ferrule 31, so that the optical fiber ferrule 31 can be stably snapped on the panel 41. Therefore, it only needs to insert the optical fiber ferrule 31 of the optical fiber receptacle 30 into the snapping groove 43, operation is more convenient.

Specifically, in the present embodiment, the panel 41 is provided with the four snapping grooves 43. The snapping grooves 43 includes two first snapping grooves 431 and two second snapping grooves 432 arranged up and down, where an opening of the first snapping groove 431 is toward an upper side edge of the panel 41, an opening of the second snapping groove 432 is toward a lower edge side of the panel 41. That is, the upper side edge of the panel 41 is provided with the two first snapping grooves 431 whose openings are toward the up, the lower side edge of the panel 41 is provided with the two second snapping grooves 432 whose openings are toward the down.

A front side surface of the panel 41 which is toward the circuit board 20 is provided with a strengthening rib 411. The strengthening rib 411 may be plural in number, and the strengthening ribs 411 intersect with each other to promote strength of the panel 41.

Specifically, in the present embodiment, the elastic locking arm 42 is positioned at two opposite sides of the panel 41. The elastic locking arm 42 extends forwardly from the panel 41.

The elastic locking arm 42 may be at least two in number, the elastic locking arms 42 respectively correspond to the two inner side walls of the receiving groove 11 which face each other. The two elastic locking arms 42 correspondingly cooperate with the two inner side walls of the receiving groove 11 respectively. Specifically, in the present embodiment, a transverse width of the receptacle bracket 40 is equal to a width of the receiving groove 11, the receptacle bracket 40 can stably slide along the bottom of the receiving groove 11. Wherein, a length direction of the housing 10 is longitudinal, a width direction of the housing 10 is transverse. The elastic locking arms 42 and the inner side walls of the receiving groove 11 retain contact therebetween. Therefore, when the receptacle bracket 40 is pushed rearwardly, the elastic locking arms 42 can sequentially latch with the inserting grooves 12 and the locking grooves 13 respectively.

Referring to FIG. 6, the elastic locking arm 42 extends forwardly from the panel 41. The elastic locking arm 42 includes an elastic portion 421 and a position-limiting protrusion 422 provided to a front end of the elastic portion 421. The elastic portion 421 is an elastic arm which extends forwardly from a side edge of the panel 41 and is elongated. The elastic portion 421 is parallel to the inner side wall of the receiving groove 11, and extends a length in the front-rear direction so that the elastic portion 421 has elasticity. The elastic portion 421 may be convenient for the elastic locking arm 42 to move along the inner side wall of the housing 10.

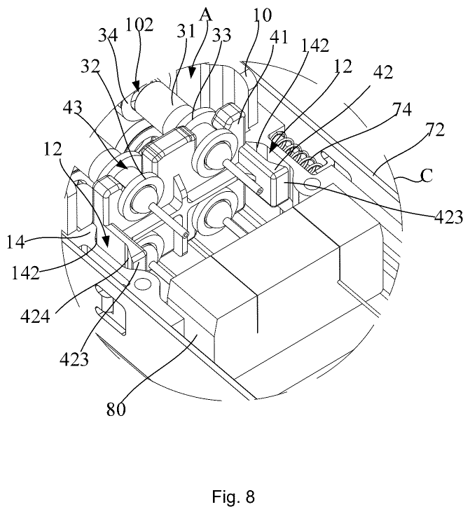

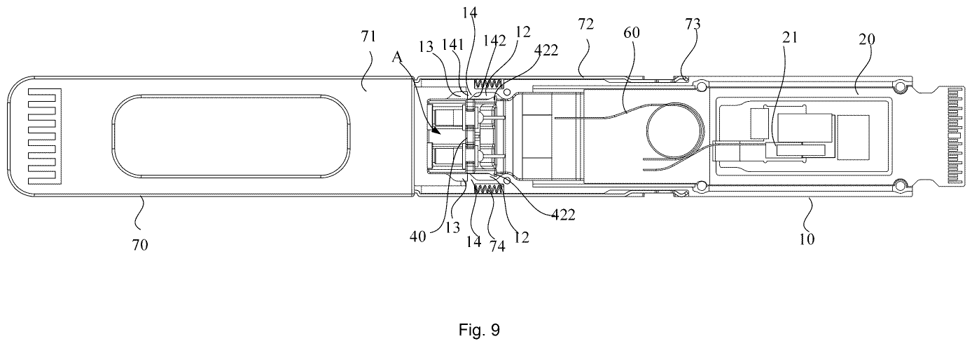

Referring to FIG. 7 and FIG. 8, the position-limiting protrusion 422 protrudes outwardly from an outer side of the elastic locking arm 42. By pushing the position-limiting protrusion 422 to move rearwardly, the position-limiting protrusion 422 can sequentially latch into the inserting groove 12 and the locking groove 13.

The position-limiting protrusion 422 includes a first position-limiting surface 423 which is toward a front side of the position-limiting protrusion 422 and a first guiding surface 424 which is toward a rear side of the position-limiting protrusion 422. A plane where the first position-limiting surface 423 is presented is preferably parallel to a plane where the panel 41 is presented. The first position-limiting surface 423 preferably is perpendicular to the front-rear direction or has a smaller inclined angle (for example 5 degrees) from the front-rear direction.

Referring to FIG. 8 and FIG. 9, the one-way passing protrusion 14 includes a second position-limiting surface 141 which is toward a rear side of the one-way passing protrusion 14 and a second guiding surface 142 which is toward a front side of the one-way passing protrusion 14.

The second position-limiting surface 141 is a rear side surface of the one-way passing protrusion 14. The second position-limiting surface 141 is parallel to the first position-limiting surface 423. When the position-limiting protrusion 422 fits into the locking groove 13, the first position-limiting surface 423 and the second position-limiting surface 141 abut against each other, the receptacle bracket 40 is hindered to move forwardly, so that the receptacle bracket 40 is retained to be fixed.

The second guiding surface 142 is a front side surface of the one-way passing protrusion 14. The first guiding surface 424 and the second guiding surface 142 are inclined relative to the front-rear direction, wherein the first guiding surface 424 may rearwardly slide over the one-way passing protrusion 14 along the second guiding surface 142. The first guiding surface 424 and the second guiding surface 142 are preferably designed as inclined or arc surfaces which match with each other, cooperating relationship between the first guiding surface 424 and the second guiding surface 142 may allow the position-limiting protrusion 422 to be capable of smoothly passing over the one-way passing protrusion 14 to slide into the locking groove 13when an operator pushes the receptacle bracket 40 rearwardly, operation is convenient.

A projected shape of the inserting groove 12 preferably is larger than a projected shape of the position-limiting protrusion 422, so that the position-limiting protrusion 422 may be allowed to move downwardly and insert into the inserting groove 12. And, in the front-rear direction, a length of the inserting groove 12 is larger than a length of the position-limiting protrusion 422. The position-limiting protrusion 422 not only can downwardly enter into the receiving groove 11 via the inserting groove 12, but also may adjust a distance between the panel 41 and the rear side wall of the receiving groove 11 along the front-rear direction via the inserting groove 12.

Specifically, the operator may push the receptacle bracket 40 to move rearwardly so that the plurality of optical fiber receptacles 30 correspondingly insert into the optical interface 102. Wherein the position-limiting protrusion 422 moves rearwardly, slides over the one-way passing protrusion 14, enters into the locking groove 13 from the inserting groove 12, and abuts against the locking groove 13 (in other words, the second position-limiting surface 141 of the one-way passing protrusion 14 toward the locking groove 13).

Specific description is performed in combination with an assembling process of the optical module 1.

Referring to FIG. 7, FIG. 8 and FIG. 9, when the operator moves the receptacle bracket 40 downwardly to make the position-limiting protrusions 422 insert into the inserting grooves 12 respectively, the panel 41 of the receptacle bracket 40 and the rear side wall of the receiving groove 11 form a first gap A therebetween. The first gap A may be used to receive parts of the optical plurality of fiber receptacles 30 rearwardly extending out of the plurality of snapping grooves 43 respectively. The position-limiting protrusions 422 move along the front-rear direction in the inserting grooves 12 respectively, which may adjust a magnitude of the first gap A to facilitate that the receptacle bracket 40 and the plurality of optical fiber receptacles 30 fall into the receiving groove 11.

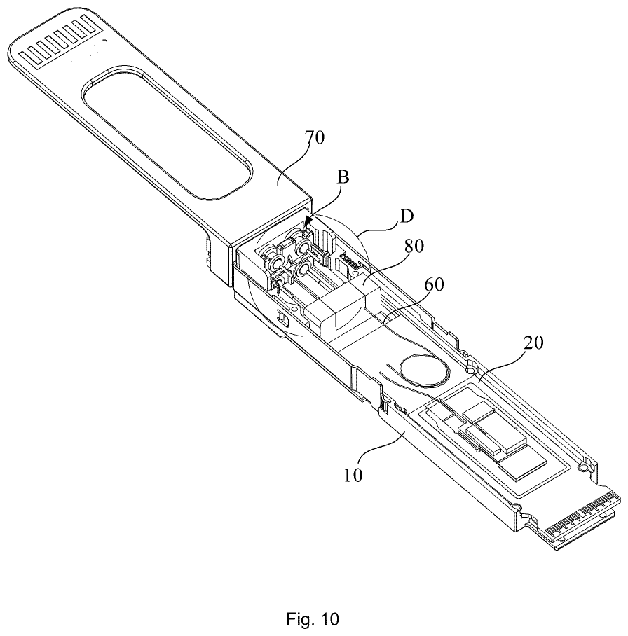

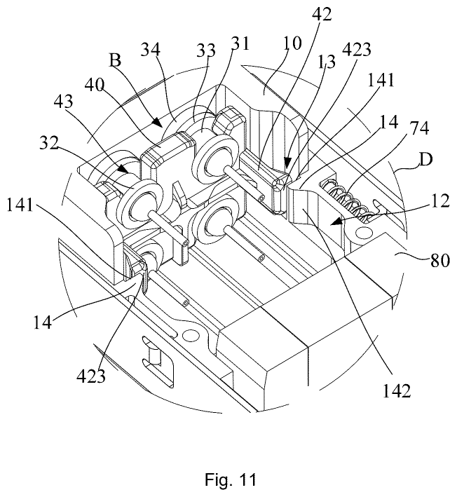

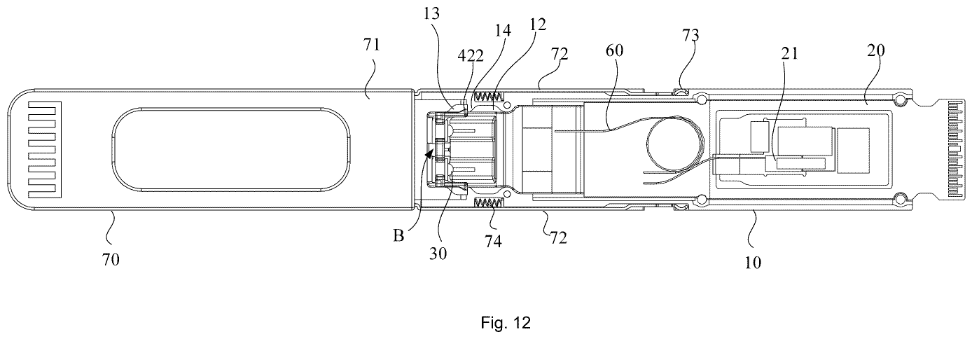

When the receptacle bracket 40 and the plurality of optical fiber receptacles 30 completely fall into the receiving groove 11, the plurality of optical fiber receptacles 30 on the receptacle bracket 40 are just aligned with the optical interface 102 along the front-rear direction. Meanwhile referring to FIG. 10, FIG. 11 and FIG. 12, when the operator pushes the receptacle bracket 40 rearwardly to move the receptacle bracket 40 rearwardly toward the optical interface 102 and insert the plurality of optical fiber receptacles 30 into the optical interface 102, at the same time, the position-limiting protrusions 422 of the elastic locking arms 42 also enter into the locking grooves 13 from the inserting grooves 12 respectively, the first position-limiting surfaces 423 and the second position-limiting surfaces 141 abut against each other, so that assembling of the plurality of optical fiber receptacles 30 is completed.

After the plurality of optical fiber receptacles 30 are inserted into the optical interface 102 and the assembling of the plurality of optical fiber receptacles 30 is completed, the panel 41 and the rear side wall of the receiving groove 11 form a second gap B therebetween. The second gap B is less than the first gap A. The second gap B may be used to receive the rear stopping edges 33 and the elastic gaskets 34 of the plurality of optical fiber receptacles 30. A sum of a thickness of the rear stopping edge 33 and a thickness of the elastic gasket 34 preferably is slightly larger than a magnitude of the second gap B, so that the elastic gaskets 34 are compressed on the rear side wall of the receiving groove 11 to further promote firmly providing and sealing of the receptacle bracket 40.

The present disclosure further provides an assembling method of an optical module which includes the following steps.

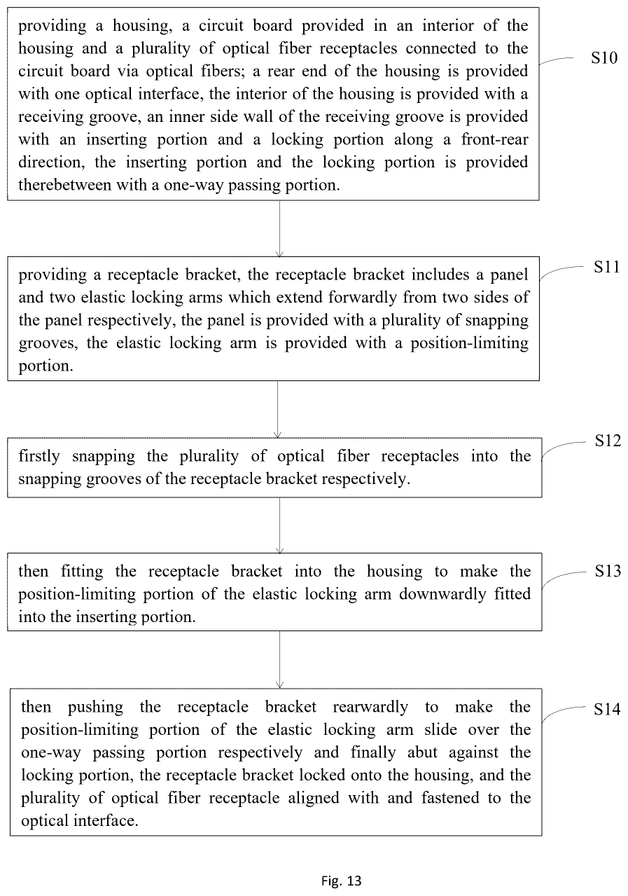

Referring to FIG. 13, at step S10, providing a housing, a circuit board provided in an interior of the housing and a plurality of optical fiber receptacles connected to the circuit board via optical fibers; a rear end of the housing is provided with one optical interface, the interior of the housing is provided with a receiving groove, an inner side wall of the receiving groove is provided with an inserting portion and a locking portion along a front-rear direction, the inserting portion and the locking portion is provided therebetween with a one-way passing portion.

Specifically, in the present embodiment, the inserting portion may be an inserting groove 12 which is recessed outwardly, the locking portion may be a locking groove 13 which is recessed outwardly, the one-way passing portion is a one-way passing protrusion 14 which protrudes inwardly relative to the inserting groove 12 and the locking groove 13. The one-way passing protrusion 14 protrudes toward the receiving groove 11. The one-way passing protrusion 14 includes a second position-limiting surface 141 and a second guiding surface 142. The second position-limiting surface 141 is a rear side surface of the one-way passing protrusion 14. The second guiding surface 142 is a front side surface of the one-way passing protrusion 14.

A step S101, that is, mounting the locking assembly 70 on the housing 10, may be further included. The locking assembly 70 is slidably connected onto the housing 10 via a sliding arm 72.

At step S11, providing a receptacle bracket, the receptacle bracket 40 includes a panel 41 and two elastic locking arms 42 which extend forwardly from two sides of the panel 41 respectively, the panel 41 is provided with a plurality of snapping grooves 43, the elastic locking arm 42 is provided with a position-limiting portion.

The elastic locking arms 42 are at least two in number, and the elastic locking arms 42 are respectively provided to two opposite sides of the panel 41. The elastic locking arms 42 extend forwardly from the panel 41. The position-limiting portion of the elastic locking arm 42 is a position-limiting protrusion 422. The position-limiting protrusion 422 protrudes outwardly from an outer side of the elastic locking arm 42. The position-limiting protrusion 422 includes a first position-limiting surface 423 and a first guiding surface 424. The first position-limiting surface 423 is a front side surface of the position-limiting protrusion 422. The first guiding surface 424 is a rear side surface of the position-limiting protrusion 422.

The first position-limiting surface 423 and the second position-limiting surface 142 abut against each other, and both are perpendicular to the front-rear direction. The first guiding surface 424 and the second guiding surface 142 are inclined relative to the front-rear direction, the first guiding surface 424 of the position-limiting protrusion 422 may rearwardly slide over the one-way passing protrusion 14 along the second guiding surface 142 of the one-way passing protrusion 14.

At step S12, firstly snapping the plurality of optical fiber receptacles 30 into the snapping grooves 43 of the receptacle bracket 40 respectively.

In the above step, it only needs to snap each optical fiber receptacle 30 into the corresponding snapping groove 43, it may realize assembling between the optical fiber receptacles 30 and the receptacle bracket 40, operation is more convenient.

At step S13, then fitting the receptacle bracket 40 into the housing 10 to make the position-limiting portions of the elastic locking arms 42 downwardly fitted into the inserting portions respectively.

Specifically, the receptacle bracket 40 is fitted into the housing 10 to make the position-limiting protrusions 422 of the elastic locking arms 42 correspondingly received in the inserting grooves 12, the receptacle bracket 40 positioned in front of the optical interface 102, and the optical fiber receptacle 30 aligned with the optical interface 102.

At step S14, then pushing the receptacle bracket 40 rearwardly to make the position-limiting portions of the elastic locking arms 42 slide over the one-way passing portions respectively and finally abut against the locking portions respectively, the receptacle bracket 40 locked onto the housing 40, and the plurality of optical fiber receptacle 30 aligned with and fastened to the optical interface 102.

Wherein, specifically, in the present embodiment, the position-limiting protrusion 422 of the elastic locking arm 42 rearwardly slides over the one-way passing protrusion 14 from the inserting groove 12 and is locked into the locking groove 13, and the plurality of optical fiber receptacles 30 are moved rearwardly and inserted into the optical interface 102, the receptacle bracket 40 is locked onto the housing 10, and the plurality of optical fiber receptacle 30 are fastened to the optical interface 102.

The present method further includes a step of covering a cover 50 above the housing 10 to seal the housing 10 and form an optical module.

Therefore, in the assembling method of the optical module of the present embodiment, as for the assembling of the plurality of optical fiber receptacles 30 and the receptacle bracket 40, it only needs to firstly insert the receptacle bracket 40 with the plurality of optical fiber receptacles 30 downwardly into the housing 10, and then push the receptacle bracket 40 rearwardly, it may realize that the plurality of optical fiber receptacles 30 are correspondingly inserted into the optical interface 102 at the same time, operation is more convenient. And, locking cooperation between the locking grooves 13 and the elastic locking arms 42 may retain position-limiting on the receptacle bracket 40, and assure positions of the plurality of optical fiber receptacles 30 to be stable. And, the assembling method of the optical module is not prone to damage the plurality of optical fiber receptacle 30 and the optical fibers 60, and thus is beneficial to promote production yield. The receptacle bracket of the optical module in the present design is an integral element, is simple in structure, and is low in manufacturing cost.

Various embodiments of the optical module are described as examples, a structure combined between various parts of the optical module is not a structure which is fixedly matched and combined, without confliction in structure, structures of various parts of the optical module of embodiments may be arbitrarily combined.

The above described contents are only the preferred embodiments of the present disclosure, which cannot limit the implementing solutions of the present disclosure, those skilled in the art may conveniently make corresponding variation or modification based on the main concept and spirit of the present disclosure, therefore the extent of protection of the present disclosure shall be determined by terms of the claims.

What is claimed is:

1. An optical module, comprising:
a housing which is provided with a receiving groove extending along a front-rear direction, an inner side wall of the receiving groove being provided with an inserting portion and a locking portion along the front-rear direction, the inserting portion being positioned in front of the locking portion, the inserting portion and the locking portion being further provided therebetween with a one-way passing portion, a rear side of the housing being provided with an optical interface;
a circuit board which is received in the receiving groove, a front end of the circuit board forwardly extending out of the housing to form an electrical interface;
a plurality of optical fiber receptacles which are coupled with the circuit board via optical fibers; and
a receptacle bracket, the receptacle bracket being provided in front of the optical interface, the receptacle bracket comprising a panel and an elastic locking arm which is provided to two sides of the panel respectively, the plurality of optical fiber receptacles snapping on the panel, the elastic locking arm being provided with a position-limiting portion;
the position-limiting portion of the elastic locking arm being capable of rearwardly sliding over the one-way passing portion from the inserting portion, entering into the locking portion and abutting against the locking portion, so that the receptacle bracket being locked to the housing, and the plurality of optical fiber receptacles being aligned with and fastened to the optical interface.

2. The optical module of claim 1, wherein
the inserting portion is an inserting groove which is recessed outwardly, the locking portion is a locking groove which is recessed outwardly, and the one-way passing portion is a one-way passing protrusion which protrudes inwardly relative to the inserting groove and the locking groove.

3. The optical module of claim 2, wherein
the position-limiting portion is a position-limiting protrusion which protrudes outwardly from an outer side of the elastic locking arm, a rear side surface of the position-limiting protrusion is provided with a first guiding surface, a front side surface of the one-way passing protrusion is a second guiding surface, and the first guiding surface and the second guiding surface are inclined relative to the front-rear direction.

4. The optical module of claim 3, wherein
the panel is provided perpendicular to the bottom of the receiving groove, and the at least two elastic locking arms forwardly extend respectively from two opposite sides of the panel.

5. The optical module of claim 3, wherein
a front side surface of the position-limiting protrusion is a first position-limiting surface, a rear side surface of the one-way passing protrusion which is toward the locking groove is a second position-limiting surface, and the first position-limiting surface abuts against the second position-limiting surface.

6. The optical module of claim 1, wherein
the optical module further comprises a cover and a locking assembly, the cover covers above the housing to close the receiving groove, and the cover is provided with a heat sink;
the locking assembly comprises a handle and a sliding arm which is fixed in front of the handle; and
a front end of the sliding arm is provided with a latch.

7. The optical module of claim 1, wherein
the optical fiber receptacle comprises an optical fiber ferrule and a front stopping edge and a rear stopping edge which are provided to an outer side of the optical fiber ferrule, and the front stopping edge and the rear stopping edge respectively attach to a front side and a rear side of the panel to limit the optical fiber ferrule in position.

8. The optical module of claim 7, wherein
the optical fiber receptacle further comprises an elastic gasket, the elastic gasket sheathes an outer periphery of the optical fiber ferrule, and the elastic gasket is provided between the rear stopping edge and the housing.

9. The optical module of claim 1, wherein
the panel is provided with a plurality of snapping grooves which are used to snap the plurality of optical fiber receptacles respectively, the plurality of snapping grooves comprise a first snapping groove and a second snapping groove which are arranged up and down, an opening of the first snapping groove is toward an upper side edge of the panel, and an opening of the second snapping groove is toward a lower side edge of the panel.

10. The optical module of claim 1, wherein
the circuit board and the receptacle bracket are further provided therebetween with a spacing member, and the spacing member is provided with a plurality of slits to correspondingly snap different optical fibers.

11. An assembling method of an optical module, comprising steps of:
providing a housing, a circuit board provided in an interior of the housing and a plurality of optical fiber receptacles connected to the circuit board via optical fibers, a rear end of the housing being provided with one optical interface, the interior of the housing being provided with a receiving groove, an inner side wall of the receiving groove being provided with an inserting portion and a locking portion along a front-rear direction, and the inserting portion and the locking portion being provided therebetween with a one-way passing portion;
providing a receptacle bracket, the receptacle bracket comprising a panel and two elastic locking arms which extend forwardly from two sides of the panel, the panel being provided with a plurality of snapping grooves, and the elastic locking arm being provided with a position-limiting portion;
firstly snapping the plurality of optical fiber receptacles into the plurality of snapping grooves of the receptacle bracket respectively;
then fitting the receptacle bracket into the housing to downwardly fit the position-limiting portion of the elastic locking arm into the inserting portion;
then pushing the receptacle bracket rearwardly to make the position-limiting portion of the elastic locking arm slide over the one-way passing portion and finally abut against the locking portion, the receptacle bracket locked onto the housing, and the plurality of optical fiber receptacles aligned with and fastened to the optical interface.

12. The assembling method of the optical module of claim 11, wherein
the inserting portion is an inserting groove which is recessed outwardly, the locking portion is a locking groove which is recessed outwardly, and the one-way passing portion is a one-way passing protrusion which protrudes inwardly relative to the inserting groove and the locking groove.

13. The assembling method of the optical module of claim 12, wherein
the position-limiting portion is a position-limiting protrusion which protrudes outwardly from an outer side of the elastic locking arm, a rear side of the position-limiting protrusion is provided with a first guiding surface, a front side surface of the one-way passing protrusion is a second guiding surface, the first guiding surface and the second guiding surface are inclined relative to the front-rear direction, in an assembling process, and the first guiding surface of the position-limiting protrusion slides over the one-way passing protrusion along the second guiding surface of the one-way passing protrusion.

14. The assembling method of the optical module of claim 13, wherein
a front side surface of the position-limiting protrusion is a first position-limiting surface, a rear side surface of the one-way passing protrusion which is toward the locking groove is a second position-limiting surface, the first position-limiting surface and the second position-limiting surface are perpendicular to the front-rear direction, and after the assembling is completed, the first position-limiting surface of the elastic locking arm abuts against the second position-limiting surface of the one-way passing protrusion.
